(19) United States
(12) Patent Application Publication
(10) Pub. No.: US 2026/0274099 A1
(43) Pub. Date: Sep. 17, 2026

(54) TERMINAL AND CABLE ASSEMBLY AND CHARGING GUN

(71) Applicant: Luxshare Precision Industry (Jiangsu)Co.,Ltd., Changzhou City (CN)

(72) Inventors: Peiquan LIN, Changzhou City (CN); Peiwei LIN, Changzhou City (CN); Xiangfeng SHEN, Changzhou City (CN); Xingran TANG, Changzhou City (CN); Yunbo LINGHU, Changzhou City (CN)

(73) Assignee: Luxshare Precision Industry (Jiangsu)Co.,Ltd., Changzhou City (CN)

(21) Appl. No.: 19/343,006

(22) Filed: Sep. 29, 2025

(30) Foreign Application Priority Data
Mar. 13, 2025 (CN) 202510302199.1
Jul. 23, 2025 (CN) 202521554410.0

(51) Int. Cl. B60L 53/302; B60L 53/16; B60L 53/18; H01R 11/01; H01R 13/02; H01R 13/52

(52) U.S. Cl. CPC B60L 53/302; B60L 53/16; B60L 53/18; H01R 11/01; H01R 13/025; H01R 13/5202

(57) ABSTRACT

Provided are a terminal and cable assembly and a charging gun. The terminal and cable assembly includes a conductive terminal, a cooling chamber, a joint structure, and a liquid-cooled cable, an end of the cooling chamber is hermetically sleeved on the conductive terminal, and the connecting end of the conductive terminal is located in the cooling chamber; the joint structure is connected hermetically to the other end of the cooling chamber; the liquid-cooled cable includes a cable conductor and a cable jacket surrounding the cable conductor to form a cable cooling channel communicating with the interior of the cooling chamber via the joint structure, an end of the cable conductor penetrates through the joint structure and is electrically connected to the connecting end, the cable jacket is hermetically connected to the joint structure, and a cooling medium is contained in the cable cooling channel and the cooling chamber.

### CROSS-REFERENCE TO RELATED APPLICATIONS

This application claims priority to Chinese Patent Application No. 202510302199.1 filed Mar. 13, 2025, and Chinese Patent Application No. 202521554410.0 filed Jul. 23, 2025, the disclosures of which are incorporated herein by reference in their entireties.

### TECHNICAL FIELD

The present disclosure relates to the technical field of charging guns and, in particular, to a terminal and cable assembly and a charging gun.

### BACKGROUND

A new energy electric vehicle needs to be charged through a charging gun. The charging gun has a conductive terminal and a cable electrically connected to the conductive terminal, and the conductive terminal is inserted into a slot of the charging port of the new energy electric vehicle to charge the new energy electric vehicle. To improve the charging efficiency, the charging gun generally has relatively large power, and the cable with a large overcurrent generates a lot of heat. To prevent the temperature of the cable from rising excessively, the cable is generally liquid-cooled.

In the related art, the conductive terminal and the cable are cooled by two independent cooling systems, and a bulkhead is provided at the end of the cable facing the conductive terminal and is used to prevent the leakage of a cooling liquid inside the cable. The conductive terminal is cooled by a cooling tube on the outer circumference of the conductive terminal. The core of the cable is electrically connected to a conductor, and the conductor extends through the bulkhead and is electrically connected to the conductive terminal so that the cable is electrically connected to the conductive terminal. Since a lot of heat is generated at the contact portion between the conductor and the conductive terminal, where no cooling structure is provided, the temperature at the contact portion between the conductor and the conductive terminal is too high, affecting the charging efficiency of the charging gun and increasing the charging duration of the charging gun.

### SUMMARY

A terminal and cable assembly includes a conductive terminal, a cooling chamber, a joint structure, and a liquid-cooled cable.

The conductive terminal has a connecting end.

An end of the cooling chamber is hermetically sleeved on the conductive terminal, and the connecting end is located in the cooling chamber.

The joint structure is connected hermetically to the other end of the cooling chamber.

The liquid-cooled cable includes a cable conductor and a cable jacket surrounding the cable conductor, a cable cooling channel is formed between the cable jacket and the cable conductor, an end of the cable conductor penetrates through the joint structure and is electrically connected to the connecting end, the cable jacket is hermetically connected to the joint structure, the cable cooling channel communicates with the interior of the cooling chamber via the joint structure, and a cooling medium is contained in the cable cooling channel and the cooling chamber.

In an embodiment, the cooling chamber is hermetically sleeved on an end of the joint structure, and the cable jacket is hermetically sleeved on the other end of the joint structure.

In an embodiment, the joint structure includes a large-diameter section and a small-diameter section, and the large-diameter section has a greater cross-sectional area than the small-diameter section; and the cooling chamber is hermetically sleeved on the large-diameter section, and the cable jacket is hermetically sleeved on the small-diameter section.

In an embodiment, the terminal and cable assembly further includes a hoop sleeved on the cable jacket, and the hoop mates with the small-diameter section to clamp the cable jacket.

In an embodiment, a barb structure is circumferentially provided on an outer wall of the small-diameter section, and the barb structure is in an interference fit with the cable jacket.

In an embodiment, the terminal and cable assembly further includes a locking nut, locking threads are provided on an outer wall of the large-diameter section outside the cooling chamber, and the locking nut is sleeved on the locking threads and abuts against an end face of the cooling chamber.

In an embodiment, a first limiting structure is circumferentially provided on an outer wall of the joint structure, a second limiting structure is provided at the other end of the cooling chamber, and the first limiting structure is located in the cooling chamber and abuts against the second limiting structure in an axial direction of the cooling chamber.

In an embodiment, the conductive terminal is provided with a fastening screw hole, the cooling chamber is provided with a through hole, and a fastener penetrates through the through hole and is screwed into the fastening screw hole to connect the conductive terminal to the cooling chamber.

In an embodiment, a sealing ring is provided between the conductive terminal and the cooling chamber, and/or a sealing ring is provided between the joint structure and the cooling chamber.

A charging gun includes the preceding terminal and cable assembly.

### BRIEF DESCRIPTION OF DRAWINGS

To illustrate technical solutions in embodiments of the present disclosure more clearly, the drawings used in the description of the embodiments of the present disclosure are briefly described below. Apparently, the drawings described below illustrate only part of the embodiments of the present disclosure, and those of ordinary skill in the art may obtain other drawings based on the embodiments of the present disclosure and the drawings on the premise that no creative work is done.

FIG. 1 is a first view illustrating the structure of a terminal and cable assembly according to an embodiment of the present disclosure;

FIG. 2 is a second view illustrating the structure of a terminal and cable assembly according to an embodiment of the present disclosure;

FIG. 3 is an exploded view of a terminal and cable assembly according to an embodiment of the present disclosure;

FIG. 4 is a sectional view of a terminal and cable assembly according to an embodiment of the present disclosure;

FIG. 5 is an enlarged view of part A of FIG. 4 of the present disclosure;

FIG. 6 is an enlarged view of part B of FIG. 4 of the present disclosure;

FIG. 7 is a view illustrating the structure of a joint structure according to an embodiment of the present disclosure;

FIG. 8 is a view illustrating the structure of a cooling chamber according to an embodiment of the present disclosure;

FIG. 9 is a view illustrating the structure of a charging gun according to an embodiment of the present disclosure; and

FIG. 10 is a partial view illustrating the structure of a charging gun according to an embodiment of the present disclosure.

### DETAILED DESCRIPTION

To make the solved technical problems, adopted technical solutions, and achieved technical effects of the present disclosure more apparent, the technical solutions of the present disclosure are further described below in conjunction with drawings and embodiments. It is to be understood that the embodiments described herein are intended to explain the present disclosure and not to limit the present disclosure. Additionally, it is to be noted that for ease of description, only a part, not all, related to the present disclosure is illustrated in the drawings.

It is to be understood that "one embodiment" or "an embodiment" throughout the description is intended to mean that a particular feature, structure, or characteristic related to the embodiment is included in at least one embodiment of the present disclosure. Therefore, various expressions of "in one embodiment" or "in an embodiment" throughout the description do not necessarily refer to the same embodiment. Additionally, such particular features, structures, or characteristics may be combined in one or more embodiments in any suitable manner.

It is to be noted that similar reference numerals and letters represent similar components in the drawings. Therefore, once a component is defined in one drawing, the component no longer needs to be defined and interpreted in the subsequent drawings.

In the description of the present disclosure, terms "joined", "connected", and "fixed" are to be construed in a broad sense unless otherwise expressly specified and limited. For example, the term "connected" may refer to "fixedly connected", "detachably connected", or "integrated", may refer to "mechanically connected" or "electrically connected", or may refer to "connected directly", "connected indirectly through an intermediary", "connected inside two components", or "an interaction between two components". For those of ordinary skill in the art, specific meanings of the preceding terms in the present disclosure may be understood based on specific situations.

In the present disclosure, unless otherwise expressly specified and limited, when a first feature is described as "above" or "below" a second feature, the first feature may be in direct contact with the second feature, or the first feature may be in contact with the second feature via another feature therebetween. Moreover, when the first feature is described as "on", "above", or "over" the second feature, the first feature is right on, above, or over the second feature, the first feature is obliquely on, above, or over the second feature, or the first feature is simply at a higher level than the second feature. When the first feature is described as "under", "below", or "underneath" the second feature, the first feature is right under, below, or underneath the second feature, the first feature is obliquely under, below, or underneath the second feature, or the first feature is simply at a lower level than the second feature. In the description of this embodiment, "multiple" denotes two or more than two unless otherwise specified.

In the description of this embodiment, orientations or position relations indicated by terms such as "center", "longitudinal", "transverse", "length", "width", "thickness", "up", "down", "front", "rear", "left", "right", "vertical", "horizontal", "top", "bottom", "in", "out", "clockwise", "counterclockwise", "axial", "radial", and "circumferential" are based on the drawings. These orientations or position relations are intended only to facilitate description and simplify operations and not to indicate or imply that a device or component referred to must have such particular orientations or must be configured or operated in such particular orientations. Thus, these orientations or position relations are not to be construed as limiting the present disclosure. Additionally, terms "first" and "second" are used only for the distinguishing purpose and have no special meanings.

It is to be noted that when a component is described as being "fixed to" or "disposed on" the other component, the component may be directly on the other component, or an intermediary component may be between the component and the other component.

The technical solutions of the present disclosure are further described below in conjunction with the drawings and the embodiments.

This embodiment provides a terminal and cable assembly applied to a charging gun. The terminal and cable assembly can reduce a risk of an excessively high temperature during high-power charging, shorten the charging duration, and ensure the charging efficiency.

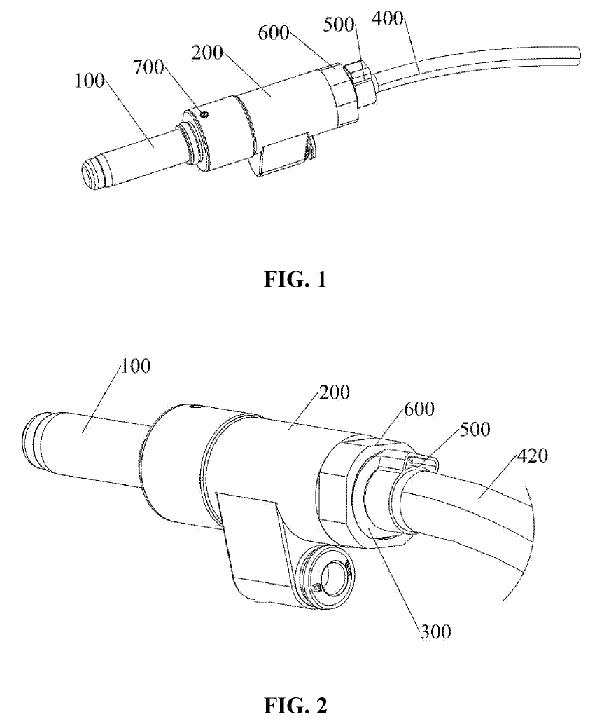

For example, as shown in FIGS. 1-10, the terminal and cable assembly 10 includes a conductive terminal 100, a cooling chamber 200, a joint structure 300, and a liquid-cooled cable 400. The conductive terminal 100 has a connecting end 110 connected to the liquid-cooled cable 400. The conductive terminal 100 also has a plug end 120 configured to be inserted into a charging port. The cooling chamber 200 has a hollow structure, and an end of the cooling chamber 200 is hermetically sleeved on the conductive terminal 100. As shown in FIG. 4, the connecting end 110 is located in the cooling chamber 200, and the cooling chamber 200 is not sleeved on the plug end 120. A cooling medium is contained in the cooling chamber 200 to cool the connecting end 110, preventing an excessively high temperature of the connecting end 110. The joint structure 300 is hermetically connected to the other end of the cooling chamber 200 to connect the cooling chamber 200 to the liquid-cooled cable 400.

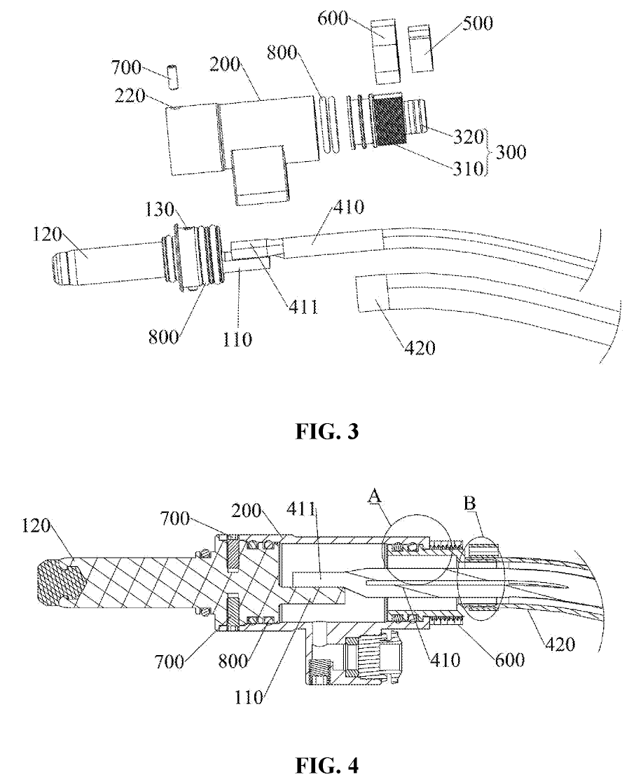

As shown in FIG. 3, the liquid-cooled cable 400 includes a cable conductor 410 and a cable jacket 420. The cable jacket 420 surrounds the cable conductor 410, and a cable cooling channel 430 is formed between the cable jacket 420 and the cable conductor 410. The cooling medium is contained in the cable cooling channel 430 to cool the cable conductor 410, preventing an excessively high temperature of the cable conductor 410. An end of the cable conductor 410 penetrates through the joint structure 300 and extends into the cooling chamber 200, and the end of the cable conductor 410 is electrically connected to the connecting end 110. Therefore, the cable conductor 410 is connected directly to the connecting end 110 of the conductive terminal 100 instead of being electrically connected to the conductive terminal 100 via another intermediary structure. Moreover, the end of the cable conductor 410 is also located in the cooling chamber 200 so that the connection position between the cable conductor 410 and the connecting end 110 is also located in the cooling chamber 200 and can be cooled by the cooling medium in the cooling chamber 200.

In some embodiments, a welding portion 411 is provided at the end of the cable conductor 410, and the welding portion 411 is electrically connected to the connecting end 110 through ultrasonic welding, to achieve relatively high connection strength. Moreover, both the welding portion 411 and the connecting end 110 are plate-shaped, and a large surface of the welding portion 411 is welded to a large surface of the connecting end 110, to achieve a relatively large connection area and relatively high connecting strength.

In this embodiment, the cable jacket 420 is hermetically connected to the joint structure 300, and the cable cooling channel 430 communicates with the interior of the cooling chamber 200 via the joint structure 300. In an embodiment, the joint structure 300 has a hollow structure, the cable cooling channel 430 communicates with the interior of the joint structure 300, and the cooling chamber 200 also communicates with the interior of the joint structure 300. In another embodiment, the joint structure 300 is provided with a channel (not shown) penetrating through the joint structure 300, the cable cooling channel 430 communicates with an end of the channel, and the interior of the cooling chamber 200 communicates with the other end of the channel.

In the terminal and cable assembly 10 of this embodiment, the cooling chamber 200 is hermetically connected to the conductive terminal 100 and the joint structure 300 so that a sealed cooling space can be formed, the connecting end 110 of the conductive terminal 100 is connected to the cable conductor 410, and the connection position is located in the cooling chamber 200. Thus, the number of connection positions is less since the liquid-cooled cable 400 is directly connected to the conductive terminal 100. Meanwhile, the cooling medium in the cooling chamber 200 can directly contact and cool the connecting end 110, the cable conductor 410, and the connection position therebetween, thereby improving the cooling efficiency of the terminal and cable assembly 10, preventing an excessively high temperature, reducing an effect of the temperature on the charging power during high-power charging, improving the charging efficiency of the charging gun to which the terminal and cable assembly 10 is applied, and shortening the charging duration of the charging gun.

Moreover, the liquid-cooled cable 400 is connected to the cooling chamber 200 via the joint structure 300, improving the connection strength between the cooling chamber 200 and the liquid-cooled cable 400. Meanwhile, the joint structure 300 is disposed so that the radial dimension of the cooling chamber 200 can be relatively large and does not need to adapt to the diameter of the liquid-cooled cable 400. Thus, the cooling medium in the cooling chamber 200 can be relatively large in volume, further improving the cooling effect on the connecting end 110 and the end of the cable conductor 410. Additionally, the joint structure 300 is disposed so that the connection sealability between the liquid-cooled cable 400 and the cooling chamber 200 can be improved, and the leakage of the cooling medium can be reduced.

In some embodiments, the cooling chamber 200 is made of a metal material. When the cooling chamber 200 is made of the metal material, the cooling chamber 200 has relatively high structural strength and pressure resistance, and meanwhile, the cooling chamber 200 has relatively high sealability, reducing a risk of leakage of the cooling medium. Of course, it is to be understood that the cooling chamber 200 may be made of a non-metal material, which is not limited in this embodiment.

The joint structure 300 in this embodiment may be made of a metal material. Thus, the joint structure 300 has relatively high structural strength, pressure resistance, and sealability, reducing the risk of leakage of the cooling medium. Of course, it is to be understood that the joint structure 300 may be made of a non-metal material, which is not limited in this embodiment.

To further enhance the sealing connection between the cooling chamber 200 and the liquid-cooled cable 400, in an embodiment, the cooling chamber 200 is hermetically sleeved on an end of the joint structure 300, and the cable jacket 420 is hermetically sleeved on the other end of the joint structure 300. Thus, the cooling chamber 200 can be in contact with the joint structure 300 by a large area, thereby enhancing the sealing connection between the cooling chamber 200 and the joint structure 300. The cable jacket 420 can be in contact with the joint structure 300 also by a relatively large area, thereby enhancing the sealing connection between the joint structure 300 and the cable jacket 420.

It is to be understood that an end of the joint structure 300 may be hermetically sleeved on the cooling chamber 200 and/or the other end of the joint structure 300 may be hermetically sleeved on the cable jacket 420, which are not limited in this embodiment.

In order that a cross-sectional size of the cooling chamber 200 is relatively large and a cross-sectional size of the liquid-cooled cable 400 is not so large, as shown in FIG. 3, the joint structure 300 may include a large-diameter section 310 and a small-diameter section 320. The large-diameter section 310 has a greater cross-sectional area than the small-diameter section 320. For example, when the large-diameter section 310 and the small-diameter section 320 are cylindrical, the diameter of the large-diameter section 310 is greater than the diameter of the small-diameter section 320. The cooling chamber 200 is hermetically sleeved on the large-diameter section 310, and the cable jacket 420 is hermetically sleeved on the small-diameter section 320. The large-diameter section 310 and the small-diameter section 320 with different radial dimensions are disposed so that the joint structure 300, the cooling chamber 200, and the cable jacket 420 are tightly sealed, the radial dimension of the cooling chamber 200 is not affected by the cable jacket 420, and thus the cooling chamber 200 can be made relatively large to have a relatively large internal space which can accommodate the cooling medium with a relatively large volume, thereby further improving the cooling efficiency and the cooling effect of the connection position between the connecting end 110 and the cable conductor 410.

Generally, the pressure of the cooling medium inside the cooling chamber 200 and the cable cooling channel 430 is relatively large. Moreover, when the cooling medium flows from the large-diameter section 310 to the small-diameter section 320 and the cable cooling channel 430, due to a decreased flowing area, a connection between the cable jacket 420 and the small-diameter section 320 is subjected to larger pressure. To prevent a connection failure between the cable jacket 420 and the small-diameter section 320, in some embodiments, as shown in FIG. 2, the terminal and cable assembly 10 further includes a hoop 500. The hoop 500 is sleeved on the cable jacket 420 and mates with the small-diameter section 320 to clamp the cable jacket 420. The hoop 500 can tightly hoop the cable jacket 420 to the small-diameter section 320, improving the connection strength between the cable jacket 420 and the small-diameter section 320 and the overall pressure resistance of the terminal and cable assembly 10, preventing the cable jacket 420 from being disconnected from the small-diameter section 320, and achieving relatively high reliability.

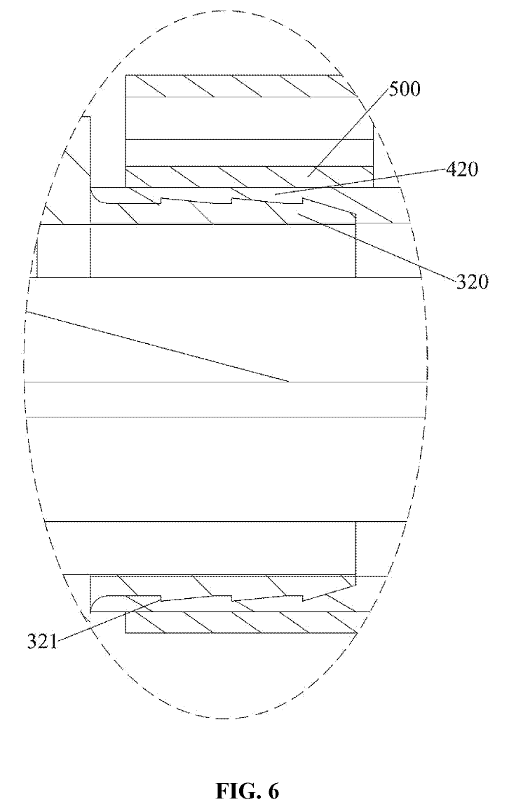

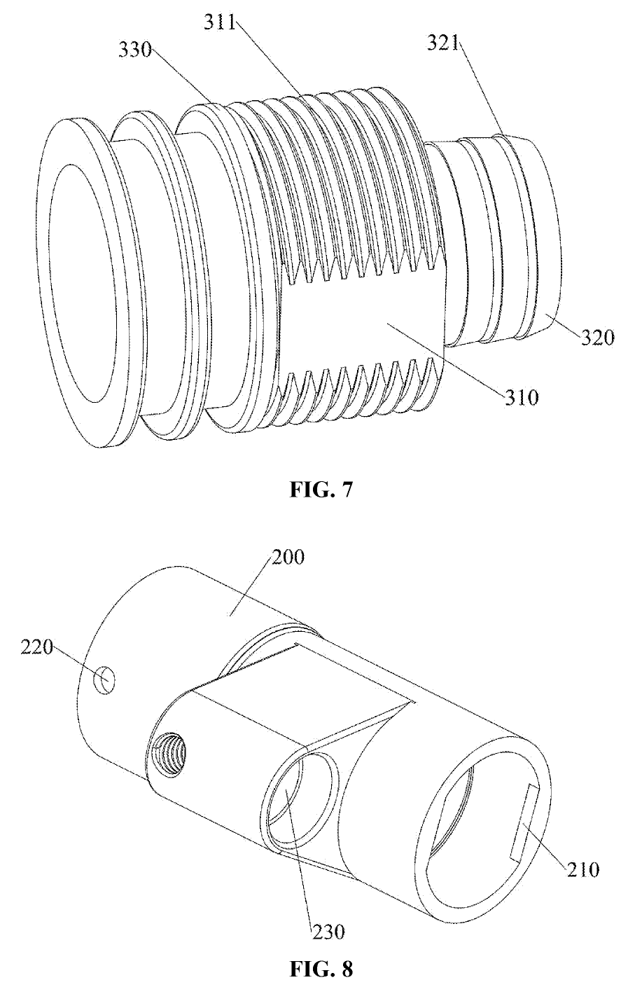

Further, as shown in FIGS. 6 or FIG. 7, a barb structure 321 is circumferentially provided on an outer wall of the small-diameter section 320, and the barb structure 321 is in an interference fit with the cable jacket 420, that is, the barb structure 321 sticks into an inner wall of the cable jacket 420. The barb structure 321 mates with the hoop 500 so that the connection strength between the small-diameter section 320 and the cable jacket 420 is further improved, and the small-diameter section 320 is at a smaller risk of being disconnected from the cable jacket 420.

As shown in FIG. 7, multiple barb structures 321 are provided and arranged in sequence along the axial direction of the small-diameter section 320, further improving the connection strength between the small-diameter section 320 and the cable jacket 420.

It is to be noted that the cable jacket 420 in this embodiment may be made of a metal material or a non-metal material or may be a combination of a metal jacket and a non-metal jacket, which is not limited in this embodiment.

To prevent the cooling chamber 200 from moving relative to the large-diameter section 310 of the joint structure 300, in an embodiment, as shown in FIGS. 3-5, the terminal and cable assembly 10 further includes a locking nut 600. Locking threads 311 are provided on an outer wall of the large-diameter section 310 outside the cooling chamber 200, and the locking nut 600 is sleeved on the locking threads 311 and abuts against an end face of the cooling chamber 200. Thus, the locking nut 600 can limit the cooling chamber 200 and prevent the cooling chamber 200 from moving relative to the large-diameter section 310, thereby improving the connection strength between the cooling chamber 200 and the large-diameter section 310 and ensuring the sealability of the formed cooling space.

In some other embodiments, the locking nut 600 may be directly welded to the large-diameter section 310, which is not limited in this embodiment.

To improve the connection strength between the conductive terminal 100 and the cooling chamber 200, as shown in FIG. 3, the conductive terminal 100 may be provided with a fastening screw hole 130; as shown in FIG. 8, the cooling chamber 200 is provided with a through hole 220; as shown in FIG. 4, the terminal and cable assembly 10 further includes a fastener 700, and the fastener 700 penetrates through the through hole 220 and is screwed into the fastening screw hole 130 to connect the conductive terminal 100 to the cooling chamber 200. Thus, the cooling chamber 200 does not move relative to the conductive terminal 100 in the axial direction of the cooling chamber 200, thereby improving the connection strength between the cooling chamber 200 and the conductive terminal 100 and ensuring the sealability of the formed cooling space.

In one or more embodiments, one or more fasteners 700 may be provided. When multiple fasteners 700 are provided, multiple through holes 220 and multiple fastening screw holes 130 are provided in one-to-one correspondence with the multiple fasteners 700 so that the connection strength between the cooling chamber 200 and the conductive terminal 100 can be further improved.

For example, the fastener 700 in this embodiment may be a bolt, and the head of the bolt is located in the through hole 220 without interference with other components, thereby preventing the fastener 700 from occupying too much space and facilitating the miniaturization of the terminal and cable assembly 10.

It is to be noted that the end of the cooling chamber 200 is connected to the conductive terminal 100 through the fastener 700, the other end of the cooling chamber 200 is locked by using the locking nut 600, and the connecting end 110 of the conductive terminal 100 is connected to the welding portion 411 of the cable conductor 410, so that the cooling chamber 200 does not move relative to the conductive terminal 100 and the liquid-cooled cable 400, thereby improving the integrity of the structure formed by the cooling chamber 200, the conductive terminal 100, the joint structure 300, and the liquid-cooled cable 400 and reducing the risk of leakage of the cooling medium.

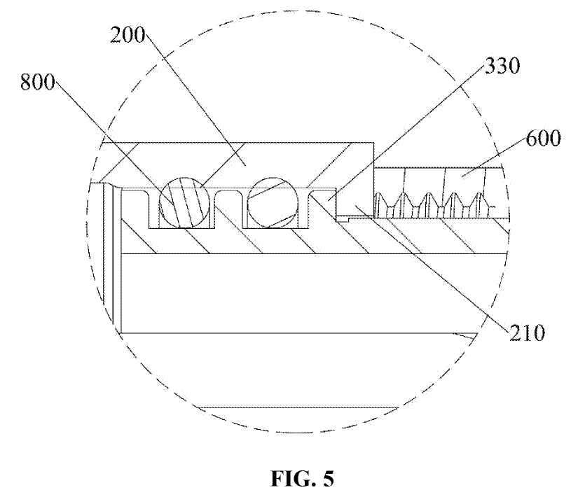

In this embodiment, the through hole 220 is aligned with the fastening screw hole 130 so that the cooling chamber 200 can be conveniently aligned and assembled with the conductive terminal 100. To facilitate the alignment and assembly of the joint structure 300 with the cooling chamber 200, in an embodiment, as shown in FIGS. 5, 7, and 8, a first limiting structure 330 is circumferentially provided on an outer wall of the joint structure 300, a second limiting structure 210 is provided at an end of the cooling chamber 200, and the first limiting structure 330 is located in the cooling chamber 200 and abuts against the second limiting structure 210 in the axial direction of the cooling chamber 200. Thus, the cooling chamber 200 and the joint structure 300 can be positioned and assembled, and the length of the joint structure 300 in the cooling chamber 200 satisfies a requirement, ensuring the connection sealability between the cooling chamber 200 and the joint structure 300 and facilitating the mounting of a sealing structure between the cooling chamber 200 and the joint structure 300.

For example, the first limiting structure 330 is a protrusion disposed on the outer wall of the large-diameter section 310 of the joint structure 300, and the second limiting structure 210 is a protrusion disposed on an inner wall of the end of the cooling chamber 200. In an embodiment, the second limiting structure 210 is a ring along the circumferential direction of the cooling chamber 200. In another embodiment, multiple second limiting structures 210 are provided and arranged at intervals along the circumferential direction of the cooling chamber 200.

In one or more embodiments, in the axial direction of the joint structure 300, the first limiting structure 330 and the locking threads 311 are spaced apart with an interval that can just accommodate the second limiting structure 210, that is, the second limiting structure 210 can be clamped between the first limiting structure 330 and the locking threads 311, further improving the reliability and stability of connection and limiting between the cooling chamber 200 and the joint structure 300.

To improve the sealability between the conductive terminal 100 and the cooling chamber 200, in this embodiment, as shown in FIG. 4, a sealing ring 800 is provided between the conductive terminal 100 and the cooling chamber 200. The sealing ring 800 is sleeved on the conductive terminal 100 and hermetically abuts against the conductive terminal 100 and the cooling chamber 200, thereby reducing the risk of leakage of the cooling medium in the cooling chamber 200. In one or more embodiments, one or more sealing rings 800 may be provided between the conductive terminal 100 and the cooling chamber 200, which is not limited in this embodiment. In an embodiment, a groove (not shown) may be circumferentially provided on the outer wall of the conductive terminal 100, and the groove is configured to accommodate the sealing ring 800 to prevent the sealing ring 800 from moving in the axial direction of the conductive terminal 100, thereby improving the positioning effect of the sealing ring 800.

In one or more embodiments, to improve the sealability between the joint structure 300 and the cooling chamber 200, as shown in FIG. 4, the sealing ring 800 is provided between the joint structure 300 and the cooling chamber 200. The sealing ring 800 is sleeved on the joint structure 300 and hermetically abuts against the joint structure 300 and the cooling chamber 200, thereby reducing the risk of leakage of the cooling medium in the cooling chamber 200. In one or more embodiments, one or more sealing rings 800 may be provided between the joint structure 300 and the cooling chamber 200, which is not limited in this embodiment. In an embodiment, a groove (not shown) may be circumferentially provided on the outer wall of the joint structure 300, and the groove is configured to accommodate the sealing ring 800 to prevent the sealing ring 800 from moving in the axial direction of the joint structure 300, thereby improving the positioning effect of the sealing ring 800.

The cable cooling channel 430 is formed inside the liquid-cooled cable 400, that is, the liquid-cooled cable 400 is designed to have a hollow structure, affecting the structural strength of the liquid-cooled cable 400. In this embodiment, to improve the structural strength of the liquid-cooled cable 400, the terminal and cable assembly 10 further includes a support structure (not shown). The support structure is disposed in the cable jacket 420 and configured to support the cable jacket 420, improving the pressure resistance of the liquid-cooled cable 400 and the structural strength of the liquid-cooled cable 400. For example, to ensure the support effect of the support structure, an outer wall of the support structure circumferentially abuts against the inner wall of the cable jacket 420 to prevent the support structure from occupying too much space of the cooling channel.

To prevent the support structure from affecting the flow of the cooling medium, the support structure in this embodiment is provided with a support through hole communicating with the cable cooling channel 430. The support through hole penetrates through the support structure in the axial direction of the liquid-cooled cable 400 so that the cooling medium outside one end of the support structure can flow through the support through hole to the outside of the other end of the support structure, and the cable cooling channel 430 is not blocked.

It is to be noted that the support structure provided with the support through hole can support the cable jacket 420 of the liquid-cooled cable 400 and make the formed cooling channel have a relatively large cross-sectional size, and with the support of the support structure, the flowing space of the cooling medium is not reduced due to bending or squeezing, thereby ensuring the flow rate of the cooling medium and carrying more heat away by the cooling medium. For example, the end of the cable cooling channel 430 facing away from the cooling chamber 200 may be connected to a cooling source. In this case, the cooling source, the cooling chamber 200, and the cable cooling channel 430 can form a cooling loop. When the flow rate and flow velocity of the cooling medium in the cable cooling channel 430 increase, the flow rate and the flow velocity of the cooling medium in the cooling chamber 200 also increase, thereby improving the cooling effect on the conductive terminal 100 and achieving the efficient charging of the charging gun to which the terminal and cable assembly 10 is applied.

In some embodiments, the support structure may be cylindrical, which has a relatively good support effect and is convenient to manufacture. In some other embodiments, the support structure may be spiral, which can also have a relatively good support effect.

For example, the support structure may be made of a metal material to ensure the support effect on the cable jacket 420. Of course, it is to be understood that the support structure may be made of a non-metal material, which is not limited in this embodiment.

This embodiment further provides a charging gun including the preceding terminal and cable assembly 10. The terminal and cable assembly 10 of the charging gun of this embodiment can withstand a relatively large maximum overcurrent so that the charging gun can have relatively high charging efficiency.

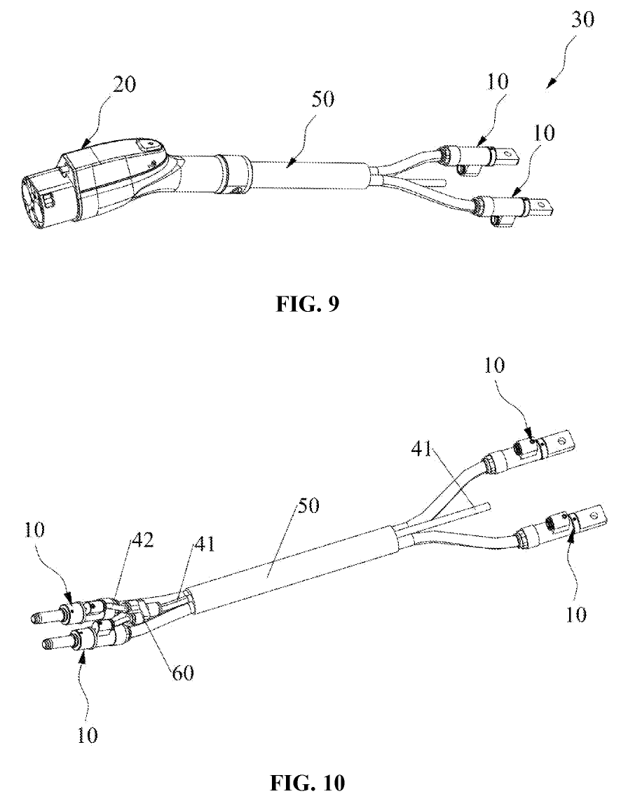

For example, FIGS. 9 and 10 show the charging gun of this embodiment, the charging gun includes a head structure 20 and a tail structure 30. The head structure 20 and the tail structure 30 each include at least one terminal and cable assembly 10, the liquid-cooled cable 400 of the terminal and cable assembly 10 of the head structure 20 is electrically connected to the liquid-cooled cable 400 of the terminal and cable assembly 10 of the tail structure 30, and the cable cooling channels 430 of the two connected liquid-cooled cables 400 communicate with each other to form a cooling loop.

For example, as shown in FIG. 10, the head structure 20 includes two terminal and cable assemblies 10, and the tail structure 30 includes two terminal and cable assemblies 10.

In an embodiment, the charging gun further includes a confluence chamber 50, and the confluence chamber 50 is disposed between the head structure 20 and the tail structure 30. For example, the confluence chamber 50 may be sleeved outside the liquid-cooled cables 400. A port 230 of each terminal and cable assembly 10 communicates with the confluence chamber 50 through tubes (not shown) so that the confluence chamber 50, the tubes, the cooling chamber 200, and the cooling channel form the cooling loop.

For example, as shown in FIGS. 9 and 10, two ends of the confluence chamber 50 are each connected to one main tube 41, ports 230 of the two terminal and cable assemblies 10 of the head structure 20 are connected to one main tube 41 via a tee 60 and two branch tubes 42, and ports 230 of the two terminal and cable assemblies 10 of the tail structure 30 are connected to the other main tube 41 via a tee 60 and two branch tubes 42.

It is to be noted that the preceding are only embodiments of the present disclosure and technical principles used therein. It is to be understood by those skilled in the art that the present disclosure is not limited to the embodiments described herein. Those skilled in the art can make various apparent modifications, adaptations, and substitutions without departing from the scope of the present disclosure. Therefore, although the present disclosure has been described in detail through the preceding embodiments, the present disclosure is not limited to the preceding embodiments and may include other equivalent embodiments without departing from the concept of the present disclosure. The scope of the present disclosure is determined by the scope of the appended claims.

What is claimed is:

1. A terminal and cable assembly, comprising:
a conductive terminal having a connecting end;
a cooling chamber, wherein an end of the cooling chamber is hermetically sleeved on the conductive terminal, and the connecting end is located in the cooling chamber;
a joint structure connected hermetically to the other end of the cooling chamber; and
a liquid-cooled cable comprising a cable conductor and a cable jacket, wherein the cable jacket surrounds the cable conductor to form a cable cooling channel between the cable jacket and the cable conductor, an end of the cable conductor penetrates through the joint structure and is electrically connected to the connecting end, the cable jacket is hermetically connected to the joint structure, the cable cooling channel communicates with an interior of the cooling chamber via the joint structure, and a cooling medium is contained in the cable cooling channel and the cooling chamber.

2. The terminal and cable assembly according to claim 1, wherein the cooling chamber is hermetically sleeved on an end of the joint structure, and the cable jacket is hermetically sleeved on the other end of the joint structure.

3. The terminal and cable assembly according to claim 1, wherein the joint structure comprises a large-diameter section and a small-diameter section, and the large-diameter section has a greater cross-sectional area than the small-diameter section; and the cooling chamber is hermetically sleeved on the large-diameter section, and the cable jacket is hermetically sleeved on the small-diameter section.

4. The terminal and cable assembly according to claim 2, wherein the joint structure comprises a large-diameter section and a small-diameter section, and the large-diameter section has a greater cross-sectional area than the small-diameter section; and the cooling chamber is hermetically sleeved on the large-diameter section, and the cable jacket is hermetically sleeved on the small-diameter section.

5. The terminal and cable assembly according to claim 3, further comprising a hoop sleeved on the cable jacket, wherein the hoop mates with the small-diameter section to clamp the cable jacket.

6. The terminal and cable assembly according to claim 5, wherein a barb structure is circumferentially provided on an outer wall of the small-diameter section, and the barb structure is in an interference fit with the cable jacket.

7. The terminal and cable assembly according to claim 3, further comprising a locking nut, wherein locking threads are provided on an outer wall of the large-diameter section outside the cooling chamber, and the locking nut is sleeved on the locking threads and abuts against an end face of the cooling chamber.

8. The terminal and cable assembly according to claim 1, wherein a first limiting structure is circumferentially provided on an outer wall of the joint structure, a second limiting structure is provided at the other end of the cooling chamber, and the first limiting structure is located in the cooling chamber and abuts against the second limiting structure in an axial direction of the cooling chamber.

9. The terminal and cable assembly according to claim 2, wherein a first limiting structure is circumferentially provided on an outer wall of the joint structure, a second limiting structure is provided at the other end of the cooling chamber, and the first limiting structure is located in the cooling chamber and abuts against the second limiting structure in an axial direction of the cooling chamber.

10. The terminal and cable assembly according to claim 1, wherein the conductive terminal is provided with a fastening screw hole, the cooling chamber is provided with a through hole, and a fastener penetrates through the through hole and is screwed into the fastening screw hole to connect the conductive terminal to the cooling chamber.

11. The terminal and cable assembly according to claim 1, further comprising at least one of a sealing ring provided between the conductive terminal and the cooling chamber or a sealing ring provided between the joint structure and the cooling chamber.

12. A charging gun, comprising a terminal and cable assembly, wherein the terminal and cable assembly comprises a conductive terminal having a connecting end, a cooling chamber, a joint structure, and a liquid-cooled cable;
wherein an end of the cooling chamber is hermetically sleeved on the conductive terminal, and the connecting end is located in the cooling chamber;
the joint structure is connected hermetically to the other end of the cooling chamber; and
the liquid-cooled cable comprises a cable conductor and a cable jacket, the cable jacket surrounds the cable conductor to form a cable cooling channel between the cable jacket and the cable conductor, an end of the cable conductor penetrates through the joint structure and is electrically connected to the connecting end, the cable jacket is hermetically connected to the joint structure, the cable cooling channel communicates with an interior of the cooling chamber via the joint structure, and a cooling medium is contained in the cable cooling channel and the cooling chamber.

13. The charging gun according to claim 12, wherein the cooling chamber is hermetically sleeved on an end of the joint structure, and the cable jacket is hermetically sleeved on the other end of the joint structure.

14. The charging gun according to claim 12, wherein the joint structure comprises a large-diameter section and a small-diameter section, and the large-diameter section has a greater cross-sectional area than the small-diameter section; and the cooling chamber is hermetically sleeved on the large-diameter section, and the cable jacket is hermetically sleeved on the small-diameter section.

15. The charging gun according to claim 14, wherein the terminal and cable assembly further comprises a hoop sleeved on the cable jacket, wherein the hoop mates with the small-diameter section to clamp the cable jacket.

16. The charging gun according to claim 15, wherein a barb structure is circumferentially provided on an outer wall of the small-diameter section, and the barb structure is in an interference fit with the cable jacket.

17. The charging gun according to claim 14, wherein the terminal and cable assembly further comprises a locking nut, wherein locking threads are provided on an outer wall of the large-diameter section outside the cooling chamber, and the locking nut is sleeved on the locking threads and abuts against an end face of the cooling chamber.

18. The charging gun according to claim 12, wherein a first limiting structure is circumferentially provided on an outer wall of the joint structure, a second limiting structure is provided at the other end of the cooling chamber, and the first limiting structure is located in the cooling chamber and abuts against the second limiting structure in an axial direction of the cooling chamber.

19. The charging gun according to claim 12, wherein the conductive terminal is provided with a fastening screw hole, the cooling chamber is provided with a through hole, and a fastener penetrates through the through hole and is screwed into the fastening screw hole to connect the conductive terminal to the cooling chamber.

20. The charging gun according to claim 12, wherein the terminal and cable assembly further comprises at least one of a sealing ring provided between the conductive terminal and the cooling chamber or a sealing ring provided between the joint structure and the cooling chamber.
